(19) United States
(12) Patent Application Publication
(10) Pub. No.: US 2003/0092788 A1
(43) Pub. Date: May 15, 2003

(54) Near infrared sensitive photopolymerizable composition

(76) Inventors: Tigran Galstian, Ste-Foy (CA); Amir Tork, Cap-Rouge (CA)

Correspondence Address: OGILVY RENAULT, 1981 MCGILL COLLEGE AVENUE, SUITE 1600, MONTREAL, QC, H3A2Y3, CA

(21) Appl. No.: 10/192,533

(22) Filed: Jul. 11, 2002

Related U.S. Application Data
(63) Continuation-in-part of application No. 09/503,207, filed on Feb. 14, 2000, now abandoned.
Application No. 09/503,207 is a continuation-in-part of application No. 09/398,091, filed on Sep. 17, 1999, now abandoned.

(51) Int. Cl. C08F 2/46

(52) U.S. Cl. 522/16; 522/7; 522/18; 522/23; 522/182

(57) ABSTRACT

A photopolymerizable composition sensitive to near infrared radiation, comprises: (i) a photopolymerizable monomer or oligomer, or a mixture thereof, capable of forming a polymer having predetermined optical properties; (ii) a photoinitiator sensitive to near infrared radiation, the photoinitiator comprising a dye sensitizer and an initiator, wherein the dye sensitizer is a cyanine dye having a perchlorate anion and the initiator is an electron donor; and (iii) a filler having optical properties selected to contrast with the optical properties of the polymer. The composition of the invention is particularly useful for producing holographic polymer dispersed liquid crystal (H-PDLC) materials and reversible dye doped polymer (RDDP) materials having improved switching characteristics.

### CROSS-REFERENCE TO RELATED APPLICATIONS

The present application is a continuation-in-part of U.S. patent application Ser. No. 09/503,207 filed Feb. 14, 2000, which is a continuation-in-part of U.S. patent application Ser. No. 09/398,091 filed Sep. 17, 1999, now abandoned.

### BACKGROUND OF THE INVENTION

The present invention relates to a photopolymerizable composition which is sensitive to near infrared radiation, and to the use of such a composition for producing various optical devices. The composition of the invention is particularly useful for producing holographic polymer dispersed liquid crystal (H-PDLC) materials and reversible dye doped polymer (RDDP) materials having improved switching characteristics.

Infrared diode sources are largely used in integrated photonic circuits and the list of their applications grows very rapidly. The management of the radiation of these sources requires the fabrication of optical elements such as lenses, interconnects, modulators, etc. Holographic diffractive elements are emerging as very promising for these applications. These include wavelength selective holographic interconnects (1 to N, or M to N), couplers, lenses, mirrors. Today, a new class of holographic polymer dispersed liquid crystal materials (H-PDLCs) is considered to be one of the most viable technologies for the development of reflective color displays, switchable holographic optical elements (such as Bragg gratings for wavelength division multiplexing (WDM) devices), switchable-focus lenses, etc. See for example Crawford et al., J. Soc. Information Display, 1997, Vol. 5, No. 1, p. 45-48; Domash et al., 1997 Digest of the IEEE/LEOS Summer Topical Meetings, SPIE, Vol. 3010, p. 214-228; and Domash et al., SPIE-Int. Soc. Opt. Eng, 1996, Vol. 2689, p. 188-194.

Commercially available holographic materials are generally sensitive only in the UV/visible region of the optical spectrum. Thus, the actual fabrication of above-mentioned elements requires an initial recording step, where a UV-visible laser source is used, and then, a further adaptation or adjustment of the obtained element for utilization with near infrared wavelengths (e.g. 790-850 nm or 1300-1500 nm), which are used in local or long distance communication systems. Due to strong astigmatism and divergence of the diode lasers used, this work is difficult and has poor efficiency. It would therefore be highly desirable to provide in situ recording of holographic diffractive elements with lasers, which are already integrated in the given photonic circuit, thus providing self-alignment of the photonic circuits. Thus, there is a need to extend the sensitivity of these materials up to communication wavelengths. Namely, for in situ holographic recording of optical components with diode lasers operating in the 790-850 nm region, among which there are vertical cavity surface emitting lasers (VCSEL), it is important to have H-PDLC materials with suitable holographic characteristics, which include high sensitivity and diffraction efficiency of the recording, low scattering and noise level, and low switching voltage.

Up to now, the sensitivity of the existing H-PDLC materials has been extended up to 790 nm only. Thus, recently, research groups have demonstrated a holographic polymerization process in a polymer-dispersed liquid crystal composite that results in efficient electrically switchable Bragg gratings (ESBG) with low scattering. The compound is sensitive to the illumination from visible up to 790 nm.

On the other hand, photopolymerizable materials have been suggested with sensitivity in the 790-850 nm region. See for example U.S. Pat. No. 4,343,891; European Patent Nos. 223,587, 387,087 and 389,067; Chatterjee et al., J. Am. Chem. Soc., 1990, Vol. 112, p. 6329-6338; Schuster et al, Photochem. Photobiol. A: Chem., 1992, Vol. 65, p. 191-196; Chatterjee et al., J. Am. Chem. Soc., 1988, Vol. 110, p. 2326-2329; Cooper et al., J. Am. Chem. Soc., 1963, Vol. 85, p. 1590-1592; and Noiret et al., Pure and Applied Optics, 1994, Vol. 3, No. 1, p. 55-71. Imaging applications with low resolution (such as printing plates) were also successfully explored. Some of the materials were the subject of the study for holographic gratings recording and only very low level of performance was achieved (7% of diffraction efficiency at sensitivity of about 300-500 mJ/cm²), as reported in the mentioned Noiret et al. article supra. This low level of performance makes such polymers impractical for commercial application. However, H-PDLC materials sensitive to the spectral region of 790-850 nm have remained unexplored.

### SUMMARY OF THE INVENTION

It is an object of the present invention to provide an efficient photopolymerizable composition that is sensitive to light in the near infrared region of the optical spectrum.

According to one aspect of the invention, there is provided a photopolymerizable composition sensitive to near infrared radiation, comprising:

a photopolymerizable monomer or oligomer, or a mixture thereof, capable of forming a polymer having predetermined optical properties;

a photoinitiator sensitive to near infrared radiator, the photoinitiator comprising a dye sensitizer and an initiator, wherein the dye sensitizer is a cyanine dye having a perchlorate anion and the initiator is an electron donor; and

a filler having optical properties selected to contrast with the optical properties of the polymer.

Applicant has found quite unexpectedly that a cyanine dye having a perchlorate anion and used in combination with an electron donor efficiently initiates photopolymerization reactions, when exposed to light in the near infrared region of the optical spectrum. Such a dye sensitizer is efficiently excited by the near infrared radiation to produce an excited sensitizer, and the initiator is efficiently excited by the excited sensitizer to cause initiation of polymerization of the monomer or oligomer, or mixture thereof. The cyanine dye is preferably 5,5′-dichloro-11-diphenylamino-3,3′-diethyl-10,12-ethylenethiatricarbocyanine perchlorate sold under the trademark IR140. The electron donor, on the other hand, preferably comprises a heavy atom such as bromine, iodine, boron, iron or the like, for example, carbon tetrabromide (CBr₄), carbon tribromide (CHBr₃) or carbon triiodide (CHI₃). Carbon tetrabromide is preferred.

An optional co-initiator can also be added to the composition. The co-initiator typically has the same role as that of the initiator. Such a co-initiator is preferably a tertiary aromatic amine, for example ethyl-dimethyl-benzoate, 1-phenylpiperidine, butyl-4-(N-morpholino)benzoate, 4-nitro-N,N-dimethylaniline, 4-(dimethylamino)benzonitrile and the like.

Use is preferably made of an acrylate monomer. A mixture comprising an acrylate monomer and an acrylate oligomer can also be used.

The filler can be a liquid crystal or a reversible dye. Use is preferably made of a reversible dye, as explained hereinbelow. Examples of suitable reversible dyes include 2-(1-(2,5-dimethyl-3-furyl)ethylidene)-3-(2-adamantylidene)succinic anhydride sold under the trademark FULGIDE or 1′,3′,3′-trimethylspiro-8-nitro-2H-1-benzopyran-2′,2′-indoline solder under the trademark SPIROPYRAN.

The above composition can be applied to prototyping and allows the implementation of optical coupling of waveguides as well as the manufacture of optical devices, in particular diffractive and holographic optical devices. Advantageously, such devices can be made using light in the near infrared region coming from a light source that is already used in the optical device, such as commonly used communications light sources.

According to another aspect of the invention, there is provided a process for producing an optical device, comprising the steps of:

a) providing an optical element;

b) providing a photopolymerizable composition as defined above;

c) applying a layer of the photopolymerizable composition onto the optical element; and

d) exposing the optical element with the layer of photopolymerizable composition thereon to near infrared radiation to cause polymerization of the monomer or oligomer, or mixture thereof, and formation of a recording pattern on the optical element, the recording pattern comprising areas having different densities of filler in exposed and unexposed areas of the layer, thereby obtaining an optical device having thereon areas with different optical properties.

The spatially periodic interference pattern of near infrared radiation initiates photopolymerization of the aforesaid composition. Where the photopolymerizable composition contains a reversible dye, this polymerization creates a diffractive grating via a spatially periodic refractive index modulation, in which the reversible dye contributes because its optical properties (refractive index, absorption) are different from the polymer matrix and its concentration varies also in the same periodic way due to the periodic polymerization and molecular diffusion phenomena. The reversible dye has various states where its optical properties are different. After the polymerization, exposition of the grating thus obtained to a blue or UV light transfers the dye into another state, with different optical properties, which reduces the refraction index modulation depth, thus reducing the diffraction efficiency of the grating and causing the recording pattern to disappear. Exposition of the grating to visible (e.g. red) light can bring back the reversible dye into its initial state, thus restoring the diffraction efficiency of the grating and causing the recording pattern to re-appear.

In a preferred embodiment, step (d) is followed by a second exposure to the near infrared radiation to cause polymerization of any remaining unpolymerized monomer oligomer.

Preferably, step (d) is carried out to ensure that substantially all of the monomer or oligomer has polymerized. The recording pattern may represent a diffraction pattern or a diffractive lens. When the recording pattern is a diffraction pattern, the diffractive element of the optical device is preferably switchable between two optical states when placed in a controllable electric field.

The photopolymerizable composition according to the invention can also be used for optically connecting at least two waveguides of an optical element. However, it is not necessary for the composition to contain the aforesaid filler.

Accordingly, the present invention also provides, in a further aspect thereof, a method of optically connecting at least two waveguides of an optical element, comprising the steps of:

a) providing an optical element having at least two waveguides to be optically connected;

b) providing a photopolymerizable composition as defined above, but containing no filler;

c) applying the photopolymerizable composition between the waveguides to be connected; and

d) exposing the waveguides with the photopolymerizable composition therebetween to near infrared radiation to cause polymerization of the monomer or oligomer, or mixture thereof, thereby forming an optical connection between the waveguides.

Preferably, the near infrared radiation is transmitted during step (d) through at least one of the waveguides.

### BRIEF DESCRIPTION OF THE DRAWINGS

Further features and advantages of the invention will become more readily apparent from the following description of a preferred embodiment, with reference to the accompanying drawings in which:

FIGS. 1A, 1B and 1C illustrate three increasing density levels of reversible dye in a RDDP material produced according to a preferred embodiment of the invention;

FIG. 2 illustrates an exposure set-up for in situ recording and monitoring of a diffractive pattern on the RDDP material;

FIG. 3 illustrates a graph of diffracted signal strength as a function of exposure time for the RDDP material, showing monotonous recording kinetics; and

FIG. 4 illustrates a graph of diffracted signal strength as a function of extended readout exposure time for the RDDP material, showing very high temporal and readout stability.

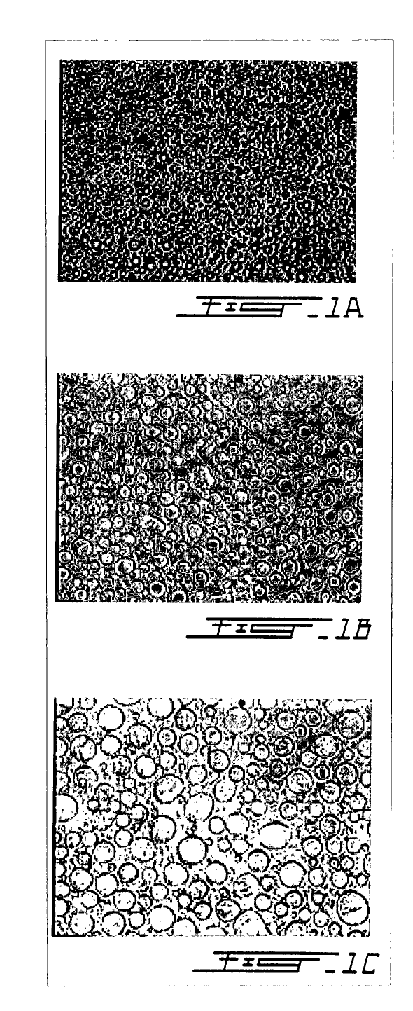

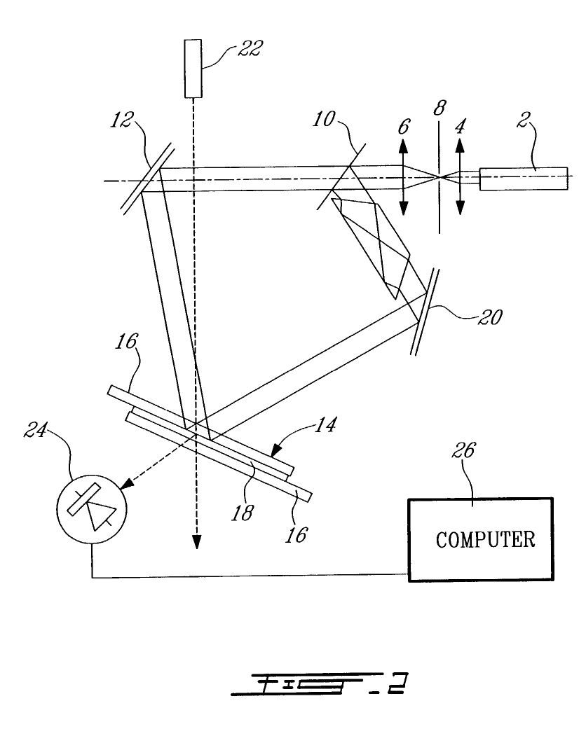

### DESCRIPTION OF PREFERRED EMBODIMENT

The photopolymerizable composition of the present invention offers a new technical solution needed to provide efficient in situ recording of highly efficient and switchable holographic elements in the near infrared region (790-850 nm) of the optical spectrum. A preferred composition according to the invention comprises a mixture of photopolymerizable acrylate monomer and oligomer, a photoinitiating system including a cyanine dye having a perchlorate anion and excitable by near infrared radiation, an electron donor, an optional co-initiator, and a reversible dye as a filler.

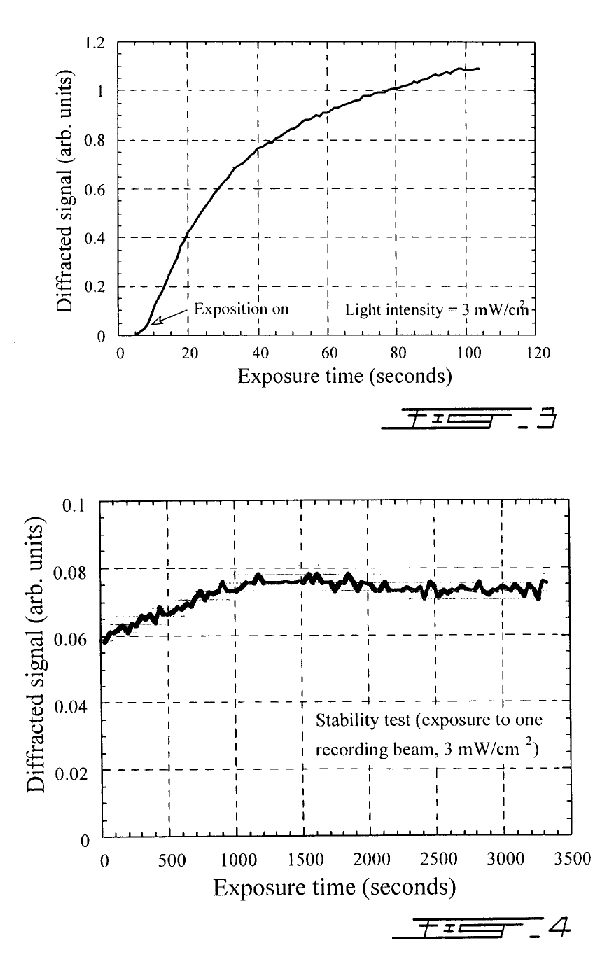

The resulting recorded holograms have high diffraction efficiency and unexpected wavelength dependence (50% at 850 nm, and 75% at 1550 nm). Indeed, with a proper choice of the components of the composition, the dispersion of the diffraction efficiency can be managed, that is, making this dependence to be growing or decreasing with the wavelength. In addition, the composition allows the DC field control of the diffraction efficiency, which can provide, e.g., switchable wavelength division multiplexing (WDM) elements. The present material shows monotonous recording kinetics (FIG. 3) and very high temporal and readout stability (after fixing; FIG. 4). The fixing is performed by uniform light illumination and no curing is required, thus increasing the capacity of the in situ fabrication of various integrated optical circuits.

The composition of the present invention has great potential since it can be modified depending on the desired performance of the final product. However, the main components remain the same. Preferred ranges of concentrations for each component are:

| | | |
|---|---|---|
| photopolymerizable acrylate | 40-80 | weight % |
| monomer and oligomer | | |
| cyanine dye | 0.02-1.0 | weight % |
| electron donor | 10-15 | weight % |
| co-initiator | 0-10 | weight % |
| reversible dye | 10-50 | weight % |
| surfactant | 0-5 | weight % |

Preparation of Composition

The preparation is preferably carried out in two stages to ensure proper solubility conditions and prevent undesirable thermal reactions.

In a first stage, the following three solutions are prepared separately by magnetic stirring at 70-90° C. and complemented with ultrasonic processing:

Solution #1: cyanine dye with liquid acrylate monomer/oligomer;

Solution #2: electron donor with liquid acrylate monomer/oligomer; and

Solution #3: co-initiator with liquid acrylate monomer/oligomer.

Mixing is continued until solubilization is complete and the solutions become homogeneous. The magnetic stirring and ultrasonic processing follow each other and each conducted for about 30 minutes. The solutions thus obtained are cooled down to and stored at room temperature for the second stage.

As a specific example, the following solutions were prepared:

Solution #1: (IR140™:DPEPA)=(0.02 to 0.2):3.3;

Solution #2: (CBr₄:DPEPA)=0.6:3.3; and

Solution #3: (EDMABzt:DPEPA)=0.4:3.3;

wherein

IR140™ is a 5,5′-dichloro-11-diphenylamino-3,3′-diethyl-10,12-ethylenethia-tricarbocyanine perchlorate (Aldrich), DPEPA is di-penta-erithrithol-penta-acrylate (Sartomer Company), and EDMABzt is ethyl-dimethyl-amino-benzoate (Aldrich).

In the second stage, the solutions are mixed together at room temperature with the reversible dye, additional monomer/oligomer and other optional conventional additives such as surfactants or plasticizers. The resulting solution is then filtered through a microporous filter to remove dust and other solid particles, and centrifuged to remove bubbles, thereby obtaining the desired photopolymerizable composition.

Examples of components which may be used in the preparation of the desired composition include:

as acrylate monomer/oligomer: DPEPA, 2-ethoxy-ethoxy-ethyl acrylate ester, urethane acrylate CN975™ or the like;

as a cyanine dye having a perchlorate anion: IR-140™, IR-132™, IR-143™, IR-786™ (Aldrich) or the like;

as an electron donor, i.e. heavy atom (preferably Br-, B-, I- or Fe-) containing compound: CBr₄, CHBr₃, CHI₃, or the like;

as a co-initiator: EDMABzt; and

as a reversible dye: FULGICIDE or SPYROPYRAN.

Sample Preparation

A layer of the above-prepared composition is disposed between two slides. A conducting coating, for example, a transparent indium tin oxide coating, can be created on the slides for switching operation. The thickness of the layer is defined by spacers, for example, made of MYLAR™ film.

Exposure of Sample

Exposure of the sample is carried out in the set up represented in FIG. 2. An 790-855 nm emitting diode laser 2 is used as an in situ recording source. The laser light is focused into a beam by lenses 4 and 6 and pinhole 8, which is directed to beamsplitter 10. The first split beam is directed to mirror 12 and then onto the cell 14 comprising the aforementioned two slides 16 with a layer 18 of photopolymerizable composition therebetween, while the second split beam is directed to mirror 20 and then onto cell 14. The readout wavelength from laser 22 is chosen to be 633 nm, which is out of the sensitivity region of the sensitizer used to ensure nondestructive monitoring of the recording process. Monitoring is carried out using a photodetector 24 and a computer 26. After recording, the sample is subjected to a stability test, which consists of a uniform exposure to one of the recording beams. This uniform exposure to the recording beam leads to full polymerization in all areas, whether exposed and non-exposed. If the hologram is stable, such an exposure would fix the created modulation of the refractive index, referred to herein as “hologram fixing”. Alternatively, i.e. if the hologram is unstable, such an exposure would lead to partial or complete erasure of the hologram.

The following non-limiting examples further illustrate the invention.

### EXAMPLE 1

According to the procedure described above, the following photopolymerizable composition was prepared:

(IR140™/DPEPA):(CBr₄/DPEPA):(EDMABzt/DPEPA):FULGICIDE:2EEEA=130:130:130:130:2;

wherein

(IR140™/DPEPA)=(0.02 to 0.2):3.3;

(CBr₄/DPEPA)=0.6:3.3;

(EDMABzt/DPEPA)=0.4:3.3.

For a thickness of 45 micrometers and spatial frequency of about 1200 lines/mm, the samples obtained exhibit the following recording parameters:

diffraction efficiency (p-polarization and wavelengths from 633 through 1500 nm): ηₚ, λ_{=633-1500 nm}=almost steady value in the range between 50 and 65%;

diffraction efficiency (s-polarization, at 633 nm): ηₚ,λ_{=633=633 nm}=21±3%.

### EXAMPLE 2

According to the procedure described above, the following photopolymerizable composition was prepared:

(IR140™/DPEPA):(CBr₄/DPEPA):(EDMABzt/DPEPA):FULGICIDE=1:1:1:1,

wherein

(IR140™/DPEPA)=(0.02 to 0.2):3.3;

(CBr₄/DPEPA)=0.6:3.3;

(EDMABzt/DPEPA)=0.4:3.3;

and which, at a thickness of 45 micrometers and a spatial frequency of 1200 lines/mm, exhibits the following recording parameters:

diffraction efficiency ηₚ, λ_{=633 nm}=47±4%;

diffraction efficiency ηₚ, λ_{=1500 nm}=70±5%;

diffraction efficiency ηₛ, λ_{=633 nm}=50±4%;

diffraction efficiency ηₛ, λ_{=1500 nm}=8±2%.

### EXAMPLE 3

According to the procedure described above, the following photopolymerizable composition was prepared:

(IR140™/DPEPA):(CBr₄/DPEPA):(EDMABzt/DPEPA):SPYROPYRAN=1:1:1:1,

wherein

(IR140™/DPEPA)=(0.02 to 0.2) 3.3;

(CBr₄/DPEPA)=0.6:3.3;

(EDMABzt/DPEPA)=0.4:3.3;

and which, at a thickness of 45 micrometers and a spatial frequency of 1200 lines/mm, exhibits the following recording parameters:

diffraction efficiency ηₚ, λ_{=633 nm}=49±4%;

diffraction efficiency ηₛ, λ_{=633 nm}=52±4%.

The monomer component of the composition can be modified, for example by adding 2EEEA, to give “zero dispersion of diffraction efficiency” of the recording. Another monomer (urethaneacrylate CN975™) gives positive dispersion of diffraction efficiency. Negative dispersion was observed with DPEPA only.

The photopolymerizable composition according to the invention can be used as an optical coupling binder which is photoreacted using light from conventional diodes operating in the near infrared region. The light for photoreacting can be provided by an external light source, or in some cases from the waveguides being coupled.

The photopolymerizable composition can also be used in non-optical devices applications, such as laser controlled prototyping, in which near infrared laser light can be used to control photopolymerization in a computer controlled manufacturing device.

We claim:

1. A photopolymerizable composition sensitive to near infrared radiation, comprising:
a photopolymerizable monomer or oligomer, or a mixture thereof, capable of forming a polymer having predetermined optical properties;
a photoinitiator sensitive to near infrared radiation, said photoinitiator comprising a dye sensitizer and an initiator, wherein said dye sensitizer is a cyanine dye having a perchlorate anion and said initiator is an electron donor; and
a reversible dye having optical properties selected to contrast with the optical properties of the polymer.

2. A composition as claimed in claim 1, wherein said monomer is an acrylate monomer.

3. A composition as claimed in claim 1, wherein said oligomer is an acrylate oligomer.

4. A composition as claimed in claim 1, wherein said cyanine dye is 5,5′-dichloro-11-diphenylamino-3,3′-diethyl-10,12-ethylenethiatricarbocyanine perchlorate.

5. A composition as claimed in claim 1, wherein saidelectron donor is selected from the group consisting of carbon tetrabromide, carbon tribromide and carbon triiodide.

6. A composition as claimed in claim 5, wherein said electron donor is carbon tetrabromide.

7. A composition as claimed in claim 1, wherein said photoinitiator further includes a co-initiator.

8. A composition as claimed in claim 7, wherein said co-initiator is ethyl-dimethyl-amino-benzoate.

9. A composition as claimed in claim 1, wherein said reversible dye is 2-(1-(2,5-dimethyl-3-furyl)ethylidene)-3-(2-adamantylidene)succinic anhydride.

10. A composition as claimed in claim 1, wherein said reversible dye is 1′,3′,3′-trimethylspiro-8-nitro-2H-1-benzopyran-2′,2′-indoline.
